(19) United States
(12) Patent Application Publication
(10) Pub. No.: US 2012/0174016 A1
(43) Pub. Date: Jul. 5, 2012

(54) CONTENT SEPARATION FOR PERSONALIZATION OF OBJECT INSTANCES

(76) Inventors: Stefan Biedenstein, Bad Schoenborn (DE); Torsten Bachmann, St. Leon-Rot (DE); Karl-Peter Nos, Nussloch (DE); Rolf Schimpfky, Dresden (DE); Thorsten Mazath, Bad Schoenborn (DE)

(21) Appl. No.: 12/980,563

(22) Filed: Dec. 29, 2010

(51) Int. Cl. G06F 3/048

(52) U.S. Cl. 715/772

(57) ABSTRACT

A system may include reception of an instruction to launch a report within a usage context, determination of a persisted view instance associated with the report based on the usage context, generation of a runtime view instance based on the persisted view instance, determination of whether the persisted view instance is associated with a first origin code or a second origin code, population, if the persisted view instance is associated with the first origin code, of a text attribute of each text field of the runtime view instance with text of a persisted user interface text instance corresponding to the text field, population, if the persisted view instance is associated with the second origin code, of the text attribute of each text field of the runtime view instance with a respective text attribute of the persisted view instance, and generation of a runtime instance of the report based on the runtime view instance.

### FIELD

Some embodiments relate to application platforms which provide services based on metaobject instances. More specifically, some embodiments relate to systems to separate and personalize metaobject instances.

### BACKGROUND

An application platform may execute applications (e.g., business processes) using data modeled on metaobjects. Types of metaobjects include a Business Object, a Business Intelligence View, a Floorplan (i.e., a user interface layout), User Interface Text, a Process Component, and a Message Type, among others. A Business Object-type metaobject, for example, is a software model representing real-world items used during the transaction of business. An instance of a Business Object metaobject may comprise a SalesOrder object model or an Organization object model. Instances of these object models, in turn, represent specific data (e.g., SalesOrder SO4711, ACME corporation).

An instance of a Business Object metaobject may specify business logic and/or data having any suitable structure. The structure may be determined based on the requirements of a business scenario in which the instance is to be deployed. A business application for a particular business scenario may require many business object instances, where the structure of each has been determined based on the requirements of the particular business scenario.

A business application may provide reports (i.e., instances of a Report metaobject) for use in analyzing business data. In some systems, the reports specify Key Figures, or calculations thereon. The reports are invoked along with an instance of a View metaobject (e.g., providing report layout information) and an instance of a Variable metaobject (e.g., specifying the data to populate the report).

It is desirable to allow a user to customize instances of metaobjects provided by the application platform. For example, a user may wish to change the text associated with a report axis as specified in a view instance. In order to support such a change, the application platform should ensure that the change is allowed in the current usage context and that the change can be saved in a manner that does not disrupt the existing platform configuration or violate tenant separation. Additional difficulties arise because text fields within an instance (e.g., within instances provided by the application platform) may themselves be represented by separate instances of a User Interface (UI) text metaobject in order to facilitate multi-language support.

### BRIEF DESCRIPTION OF THE DRAWINGS

FIG. 1 is a block diagram of a system according to some embodiments.

FIG. 2 is a block diagram illustrating persistent instances according to some embodiments.

FIG. 3 is a flow diagram of a process according to some embodiments.

FIG. 4 is a block diagram illustrating persistent and runtime instances according to some embodiments.

FIG. 5 is a block diagram illustrating persistent and runtime instances according to some embodiments.

FIGS. 6a through 6c comprise a flow diagram of a process according to some embodiments.

FIG. 7 is a block diagram illustrating persistent and runtime instances according to some embodiments.

FIG. 8 is a block diagram illustrating persistent and runtime instances during a Save operation according to some embodiments.

FIG. 9 is a block diagram illustrating persistent and runtime instances according to some embodiments.

FIG. 10 is a block diagram illustrating persistent and runtime instances during a Save operation according to some embodiments.

FIG. 11 is a block diagram illustrating persistent and runtime instances during a Save As operation according to some embodiments.

FIG. 12 is a block diagram illustrating persistent and runtime instances during a Save As operation according to some embodiments.

FIG. 13 is a block diagram of a computing device according to some embodiments.

### DETAILED DESCRIPTION

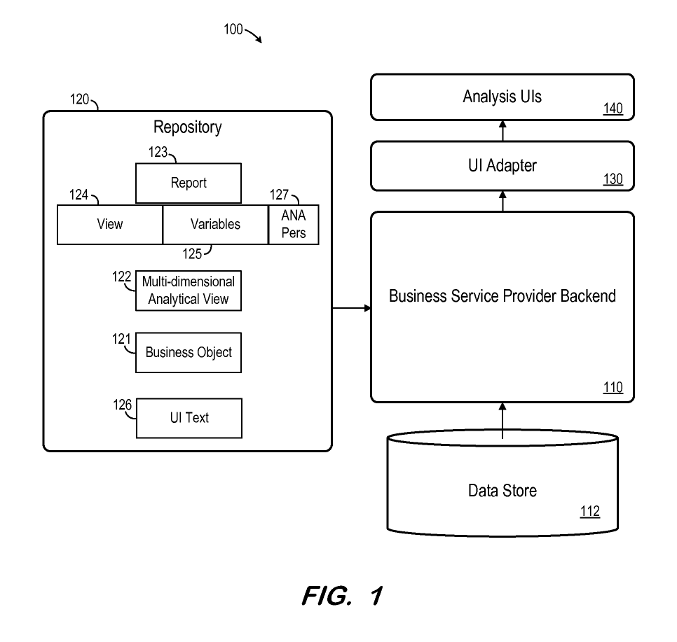

FIG. 1 is a block diagram of system 100 according to some embodiments. FIG. 1 represents a logical architecture for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

System 100 includes business service provider backend 110 for providing business services to consumers (not shown) of system 100. For example, business service provider backend 110 might store customer information into and retrieve customer information from physical tables of data store 112.

The data stored in data store 112 may be received from disparate hardware and software systems, some of which are not interoperational with one another. The systems may comprise a back-end data environment employed in a business or industrial context. The data may be pushed to data store 112 and/or provided in response to queries received therefrom.

Data store 112 may comprise a relational database, a multi-dimensional database, an eXtendable Markup Language (XML) document, or any other structured data storage system. The physical tables of data store 112 may be distributed among several relational databases, dimensional databases, and/or other data sources. To provide economies of scale, data store 112 may include data of more than one customer. Business service provider backend 110 includes mechanisms to ensure that a client accesses only the data that the client is authorized to access. Moreover, the data of data store 112 may be indexed and/or selectively replicated in an index to allow fast retrieval thereof.

The structures of and relationships between the physical database tables may be complex, and business object object models (i.e., instances of a Business Object metaobject, referred to henceforth as “business objects”) may be used to shield developers and end-users from these complexities. System 100 implements metadata models to support different business solutions.

Repository 120 includes metadata of various metaobjects. Repository 120 may also include metadata of instances of the metaobjects, referred to herein as object models or objects. The metaobjects and object models may be embodied in any type of data structure, including but not limited to eXtensible Markup Language files.

As in the conventional storage of object instance data, the metadata defining the specific metaobjects and object models (i.e., metaobject instances) may be stored in database tables of data store 112. For example, as will be described in detail below, data store 112 may store metadata describing View instances and Variable instances, some of which are provided by the application platform and some of which are user-specific. In some embodiments, the metadata of platform-provided instances are stored in “user-independent” tables of data store 112 and the metadata of user-associated instances are stored in “user-dependent” tables. The underlying data may be similarly segregated.

The various illustrated metaobjects of repository 120 will now be described. Repository 120 also includes metadata of one or more instances of each metaobject. As mentioned above, the metadata of the metaobject instances (i.e., object models) may be replicated in data store 112.

Business Object metaobject 121 provides information regarding the structure and attributes of the data of business object instances. Accordingly, backend 110 uses the metadata of Business Object metaobject 121 to access corresponding data of data store 112.

Multi-dimensional analytical view (MDAVs) metaobject 122 may comprise a metadata model as described in commonly-assigned, co-pending U.S. application Ser. No. 12/847,409, entitled “Common Modeling Of Data Access And Provisioning For Search, Query, Reporting And/Or Analytics”, the contents of which are incorporated herein by reference. Generally, a multi-dimensional analytical view describes a view on a business object. As described in U.S. application Ser. No. 12/847,409, a query definition object (not shown) may define a query on a business object, and a multi-dimensional analytical view may define the results of the query as Key Figures or Characteristics. Moreover, the multi-dimensional analytical view may define rules which are used to calculate Key Figures and to define restrictions which will be used at runtime to set predefined filter parameters.

Report metaobject 123 includes metadata describing a composite of Key Figures of MDAV metaobject 122. The ability to associate an instance of Report metaobject 123 with an instance of MDAV metaobject 122 may facilitate the incorporation of semantically-rich information within the instance of Report metaobject 123. For example, an instance of Report metaobject 123 may simply refer to Key Figures which are calculated according to MDAV 122, without having to define a query for particular data of business object 121 or a calculation of the Key Figures based on that data.

An instance of report 123 is invoked along with an instance of View metaobject 124 and an instance of Variables metaobject 125. The view instance may provide layout information (e.g., axis labels, chart type, etc.), while the variables instance further defines (e.g., via filters) the data to be presented. As described below, the report may be initially invoked using a default view instance and a default variables instance. A user may select from more than one view instance and more than one variables instance according to some embodiments.

UI text metaobject 126 facilitates multi-language support. For example, UI text fields defined within instances of any of metaobjects 121 through 125 may be associated with keys instead of actual text for display in a UI. Consequently, in order to support a particular language, instances of UI text metaobject 126 are created with the corresponding keys and text in the particular language.

Instances of ANA Pers metaobject 127 allow report personalization according to some embodiments. For example, each instance of report metaobject 123 may be associated with an instance of ANA Pers metaobject 127, which defines several default criteria related to the report. The criteria may comprise a default view instance, a default variables instance, a cache latency, etc.

Embodiments operate within different usage contexts depending on the current user, system setting, etc. Accordingly, each usage context of a particular report instance may be associated with a dedicated ANA Pers instance. More specifically, one ANA Pers instance may exist for each usage context of each report instance.

User interface (UI) adapter 130 provides reports to one or more analysis UIs 140. Analysis UIs 140 may provide browser-based reports, spreadsheet-based reports, formatted reports, and/or reports in other formats. A client system (not shown) may access one or more of analysis UIs via Web Services according to some embodiments.

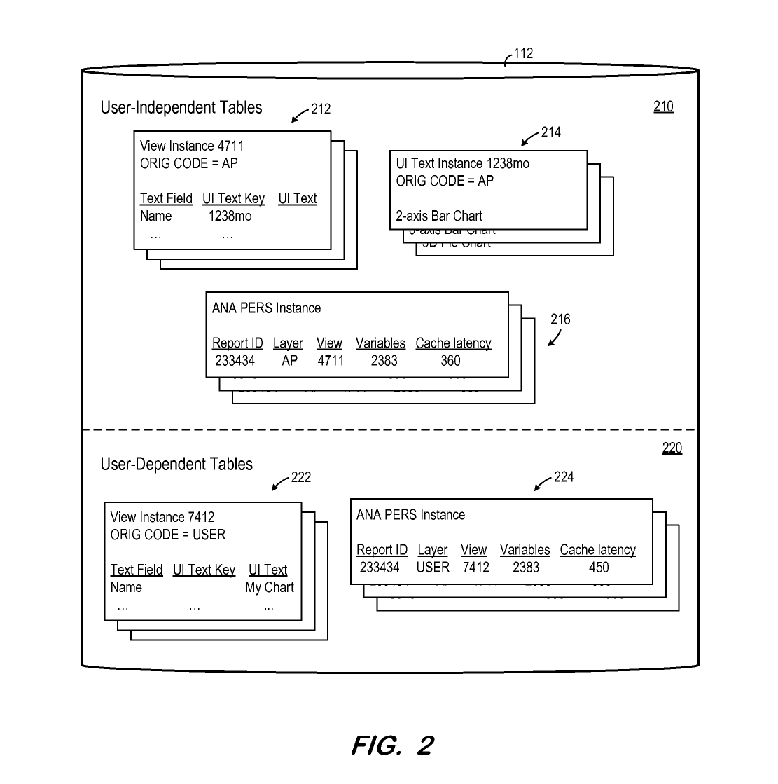

FIG. 2 is a block diagram illustrating some of the contents of data store 112 according to some embodiments. The components are represented logically; the positions thereof are not intended to imply any physical limitations. In this regard, data store 112 is visually partitioned into user-independent tables 210 and user-dependent tables 220, but actual storage may or may not follow any such physical boundaries. The instances of data store 112 will be referred to herein as persisted.

User-independent tables 210 include view instances 212, UI text instances 214 and ANA Pers instances 216. As shown, each instance of user-independent tables 210 is associated with an ORIG CODE or Layer identifier “AP”. For purposes of the present example, it will be assumed that AP signifies the application provider, and that the instance was defined by the application provider.

View instance 4711 includes text field Name, which is associated with UI text key 1238mo. View instance 4711 includes many other text fields, each associated with a UI text key. Although View metaobject 124 defines a UI text attribute for each text field, the attribute is not populated in view instances 212. Generally, view instance 4711 includes many unshown fields and attributes.

UI text instance 1238mo is illustrated among UI text instances 214. Accordingly, UI text instance 1238mo is associated with the text field Name of view instance 4711. In some embodiments, each field of each of view instances 212 is associated with a UI text instance. As described above, such an association facilitates multi-language support.

Since only a single usage layer is represented, ANA Pers instances 216 include one instance per report instance (not shown). User-independent tables 210 may include instances associated with other layers, such as a partner developer layer, or a Key User layer. User-independent tables 210 include many other instances of many other types of metaobjects. For example, although the foregoing description focuses primarily on view instances, the description applies equally to variables instances.

User-dependent tables 220 include view instances 222, and ANA Pers instances 224. Each instance of user-dependent tables 220 is also associated with an ORIG CODE or Layer identifier “USER”. It will be assumed that USER signifies a specific user, and that the instance was defined by the specific user.

View instance 7412 includes text field Name, which is associated with UI text attribute My Chart. Unlike view instance 4711, the text field is not associated with a UI text key. View instance 7412 may include many other text fields, each associated with a UI text attribute. ANA Pers instances 224 include one instance per report instance (not shown). User-dependent tables 220 include many other instances of many other types of metaobjects.

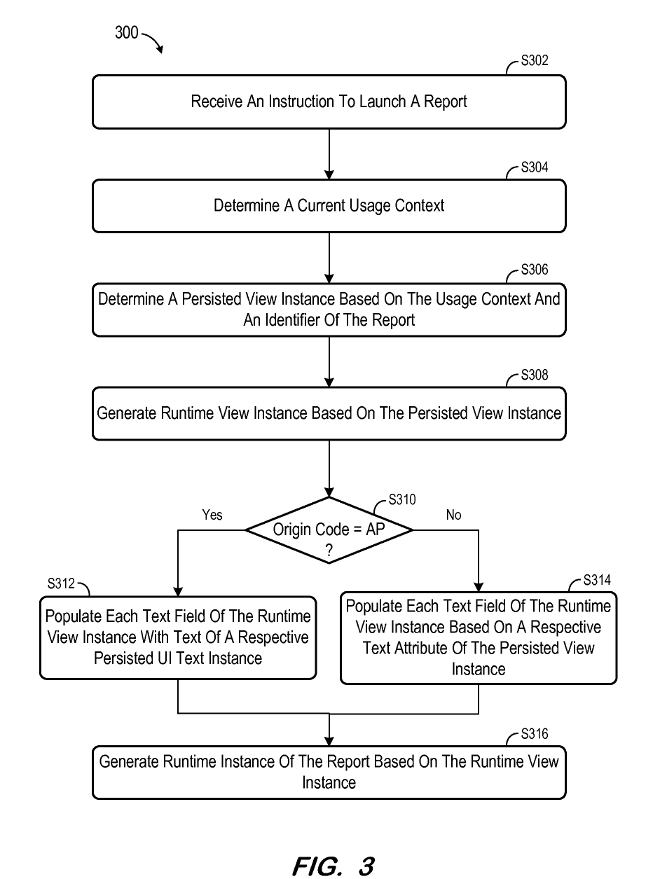

FIG. 3 is a flow diagram of process 300 according to some embodiments. Business service provider backend 110 and/or repository 120 may execute portions of process 300 as will be described below, but embodiments are not limited thereto. In this regard, all processes described herein may be executed by any combination of hardware and/or software. The processes may be embodied in program code stored on a tangible medium and executable by a computing device to provide the functions described herein. The processes described herein do not imply a fixed order to their constituent steps, and embodiments may be practiced in any order that is practicable.

Initially, an instruction to launch a report is received at S302. For example, a user may logon to one of analysis UIs 140 of system 100 and request a report instance. Next, at S304, a current usage context is determined. The usage context may be determined based on system settings, authorities of the logged-on user, and/or the currently-accessed UI. For purposes of the present example, possible usage contexts are “AP” or “USER” as described above. More or different usage contexts may be used in some embodiments, including but not limited to Partner and Key User.

A persisted view instance is determined at S306 based on the usage context and on an identifier of the report. Initially it will be assumed that the usage context is “AP” and the report is associated with the identifier 233434. With reference to the example of FIG. 2, ANA Pers instance 216 associated with this identifier and usage context is identified. The instance 216 indicates persisted view instance 4711.

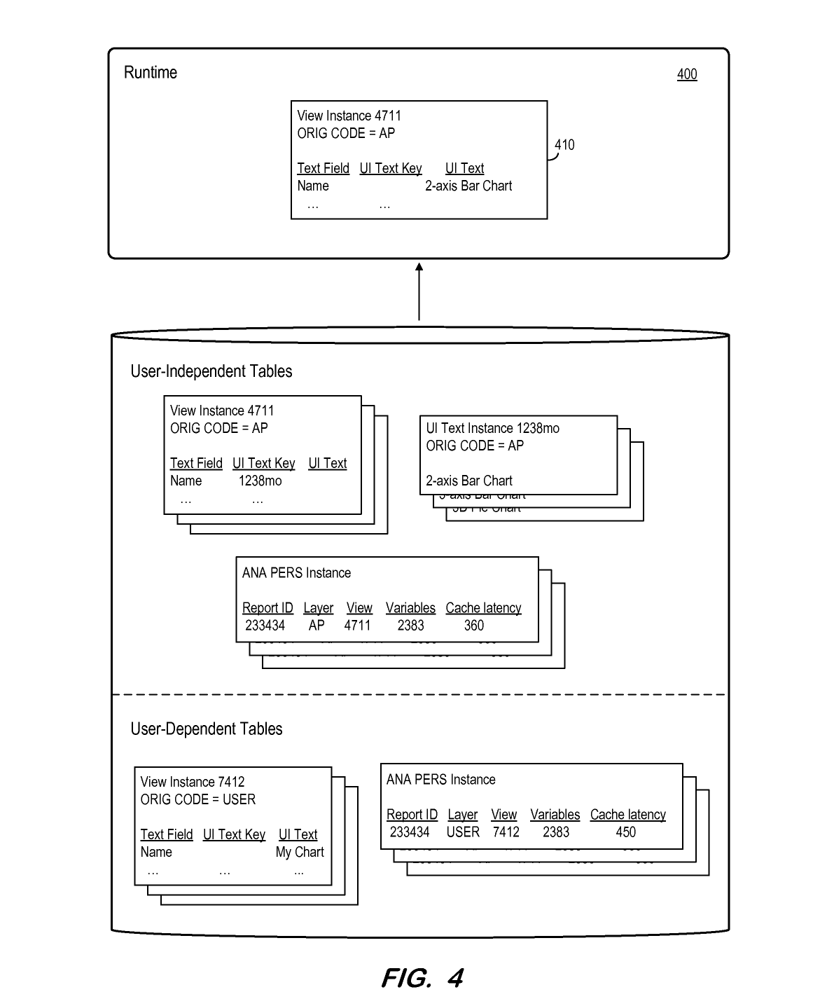

Therefore, at S308, a runtime view instance is generated based on the persisted view instance. The runtime view instance is used during generation of the report. FIG. 4 illustrates runtime layer 400 according to some embodiments. Runtime layer 400 may be implemented in backend 120. Runtime view instance 410 is shown populated with data in FIG. 4. Population of runtime view instance 410 according to some embodiments will now be described.

At S310, the ORIG CODE of the persisted view instance is determined. Flow proceeds to S312 if the code is AP, as in the current example. At S312, each text field of the runtime view instance is populated with text of a respective persisted UI text instance. For example, runtime view instance 410 includes text field Name. Persisted view instance 4711 indicates that UI text instance 1238mo corresponds to the Name text field. Therefore, the Name text field of runtime instance 410 is populated with the text of UI text instance 1238mo (i.e., “2-axis Bar Chart”). Finally, at S316, a runtime instance of the report is generated based on the runtime view instance. In this regard, a runtime instance of a persisted variables instance may also be generated as described above, and both runtime instances may be used as is known to generate a runtime report instance.

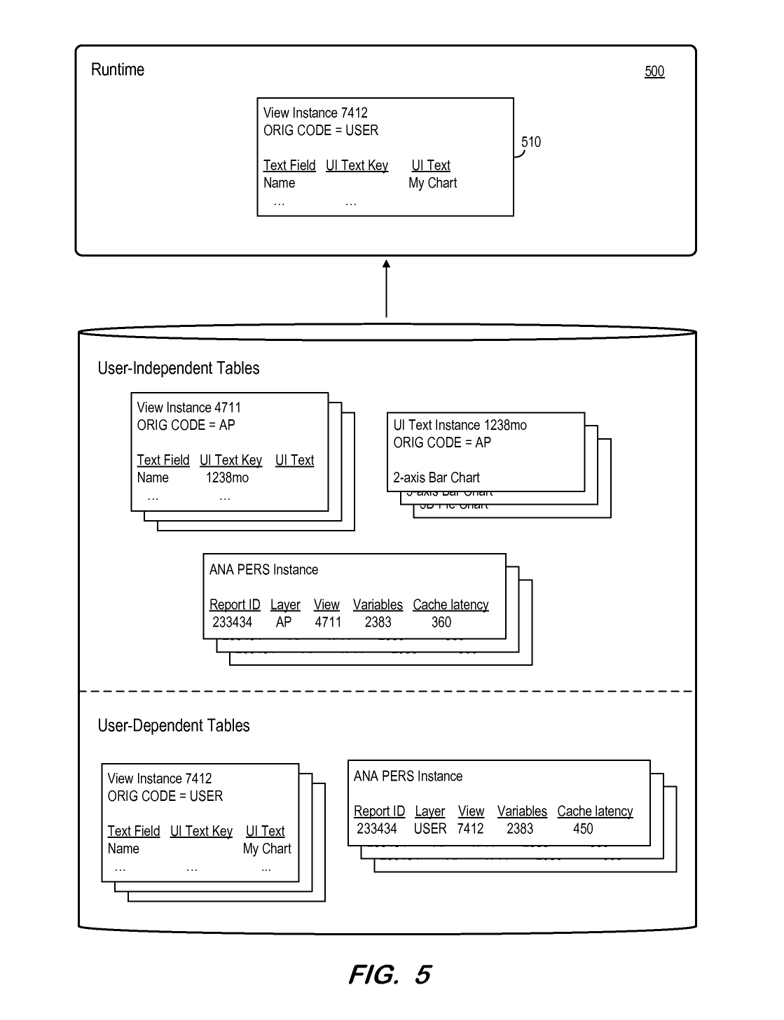

Returning to S304, it will now be assumed that the determined current usage context is USER. Therefore, persisted view instance 7412 of user-dependent tables 220 is determined at S306 based on ANA Pers instance 224 which is associated with Report ID 233434. FIG. 5 illustrates runtime view instance 510 generated at S308.

Flow proceeds from S310 to S314 because the ORIG CODE of the persisted view instance is USER. At S314, each text field of the runtime view instance is populated based on a respective text attribute of the persisted view instance. As shown, The UI text attribute associated with the Name text field is populated with the UI text attribute of View instance 7412 (i.e., My Chart). Again, at S316, a runtime instance of the report is generated based on the runtime view instance.

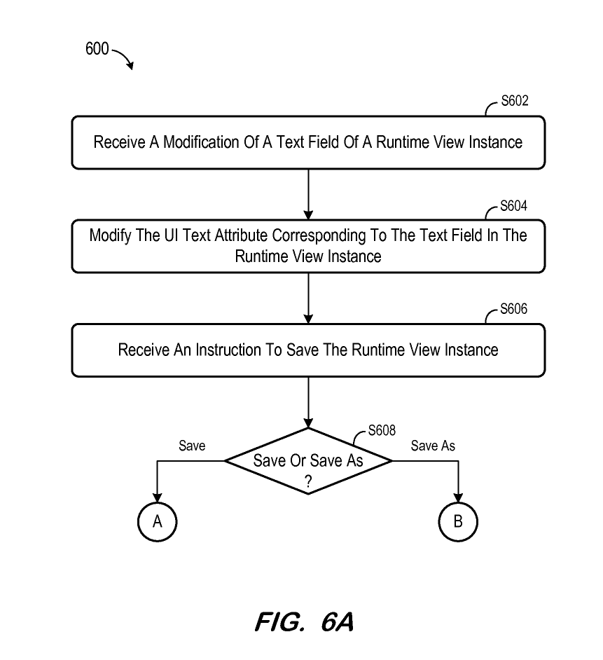

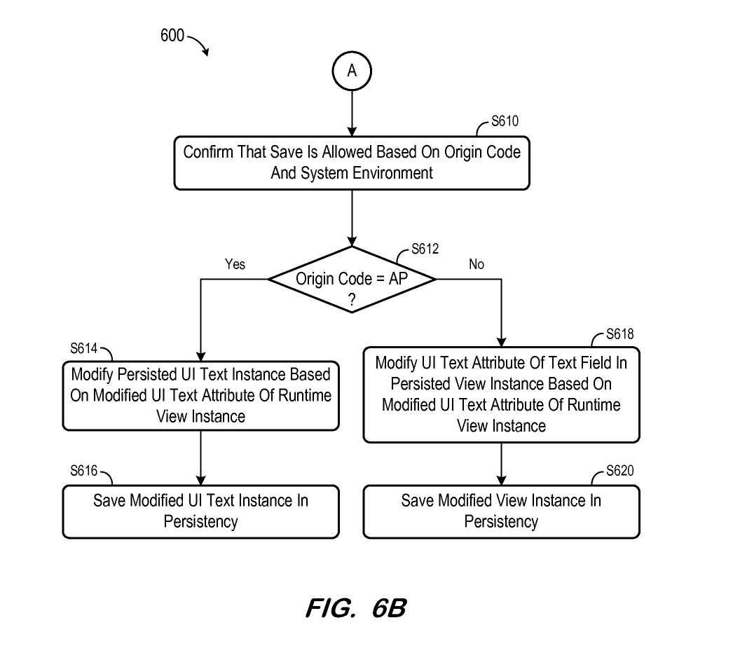

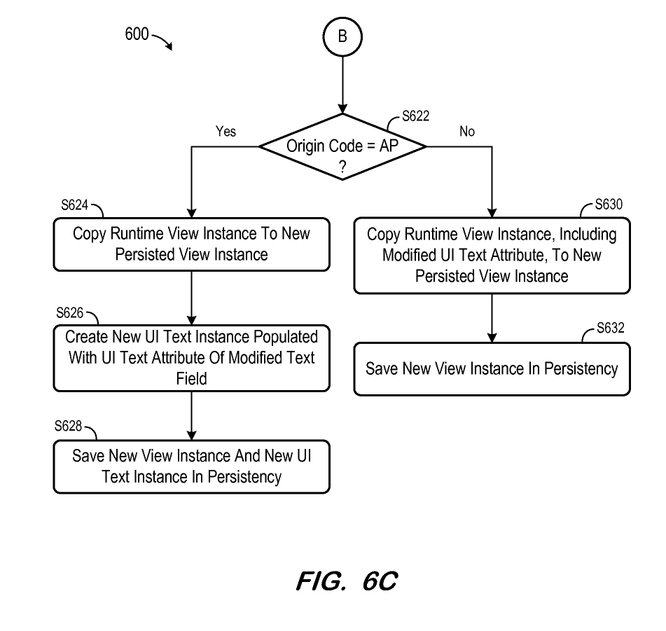

Process 600 of FIGS. 6A through 6C governs modification and saving of a runtime instance text field according to some embodiments. Initially, at S602, a modification of a text field of a runtime view instance is received. The runtime view instance may be generated as described with respect to process 300, but embodiments are not limited thereto. A user may use editing tools provided by one of analysis UIs 140 in order edit a text field (e.g., Name) of the runtime view instance.

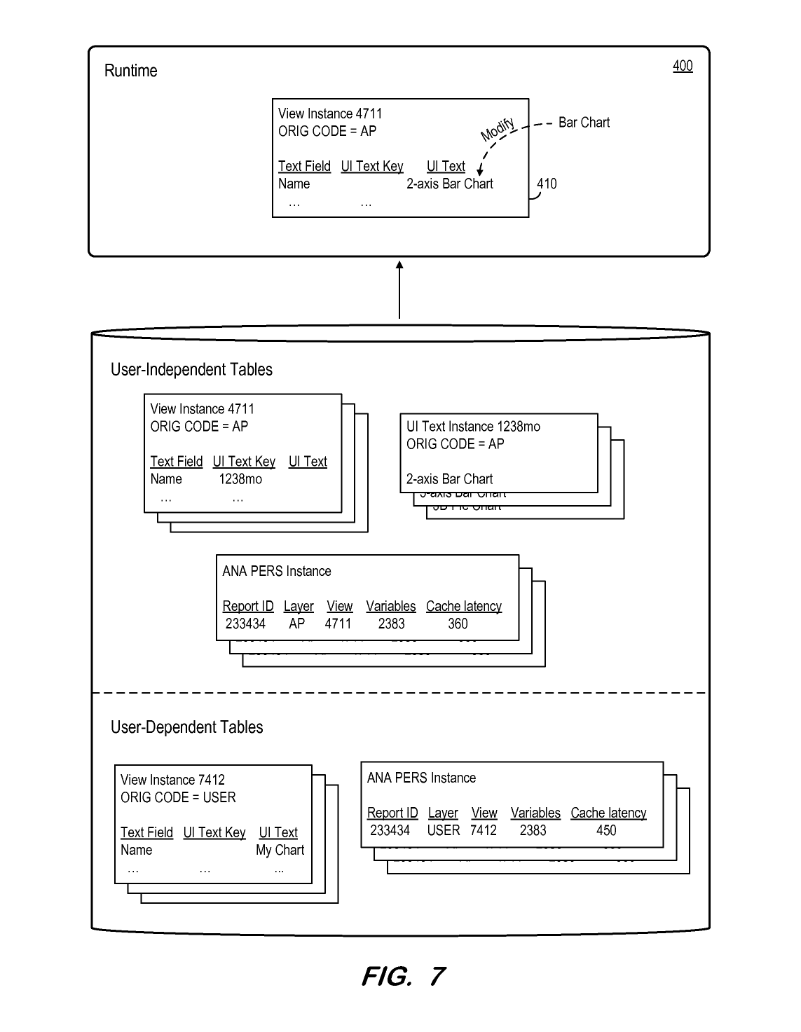

FIG. 7 illustrates S602 according to some embodiments. Name text field of runtime instance 410, originally presented in FIG. 4, is to be changed from “2-axis bar chart” to “Bar Chart”. At S604, and as illustrated in FIG. 7, a UI text attribute corresponding to the text field in the runtime view instance is modified.

Next, at S606, an instruction is received to save the runtime view instance. The instruction may comprise a “Save” operation to overwrite the corresponding persisted view instance, or a “Save As” operation to create a new persisted view instance. Assuming a “Save” instruction, flow proceeds from S608 to S610.

At S610, it is confirmed whether a Save operation is allowed based on the origin code of the runtime view instance and the system environment. Any number of rules or policies may be implemented at S610. For example, for the origin code “AP”, a Save operation may be allowed only if the system specifies that this particular instance is changeable. For the origin code “USER”, a Save operation may be allowed only if the current user is the owner of the instance. For the origin code “Key User”, a Save operation may be allowed only if the associated report instance is running in a Key User usage context.

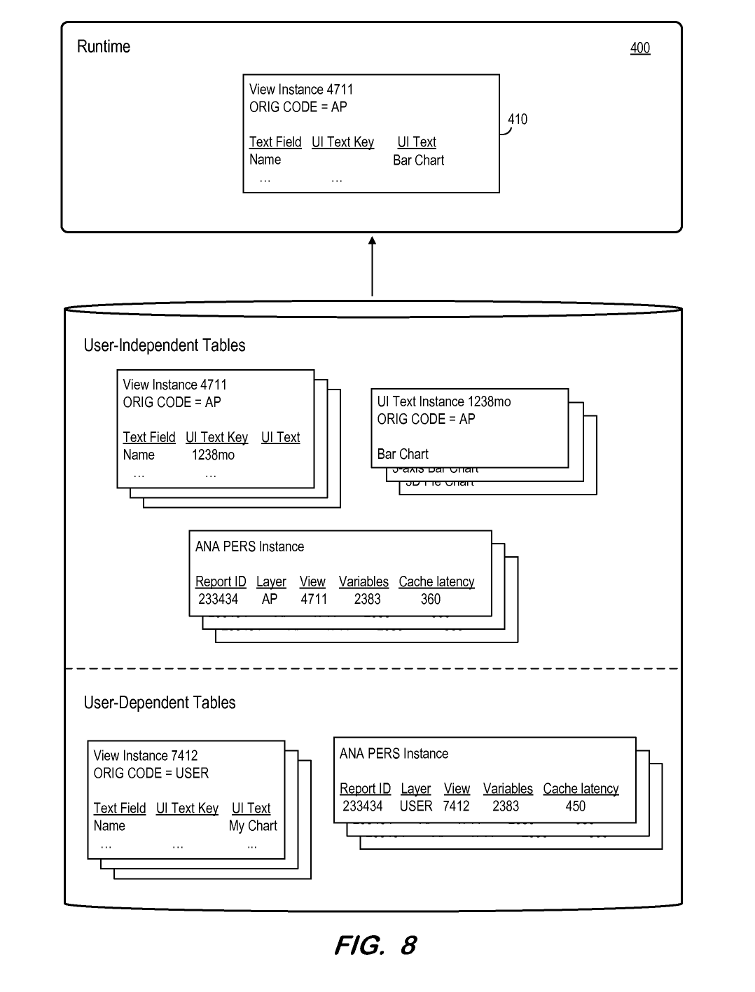

S612 determines the origin code of the runtime instance. With continued reference to FIG. 7, flow continues to S614. At S614, the persisted UI text instance associated with the modified UI text attribute is modified, and the modified UI text instance is persisted at S616. FIG. 8 shows both the modification of the UI text attribute of runtime instance 410, and the modification of persisted UI text instance 1238mo to reflect the modification of the UI text attribute of runtime instance 410.

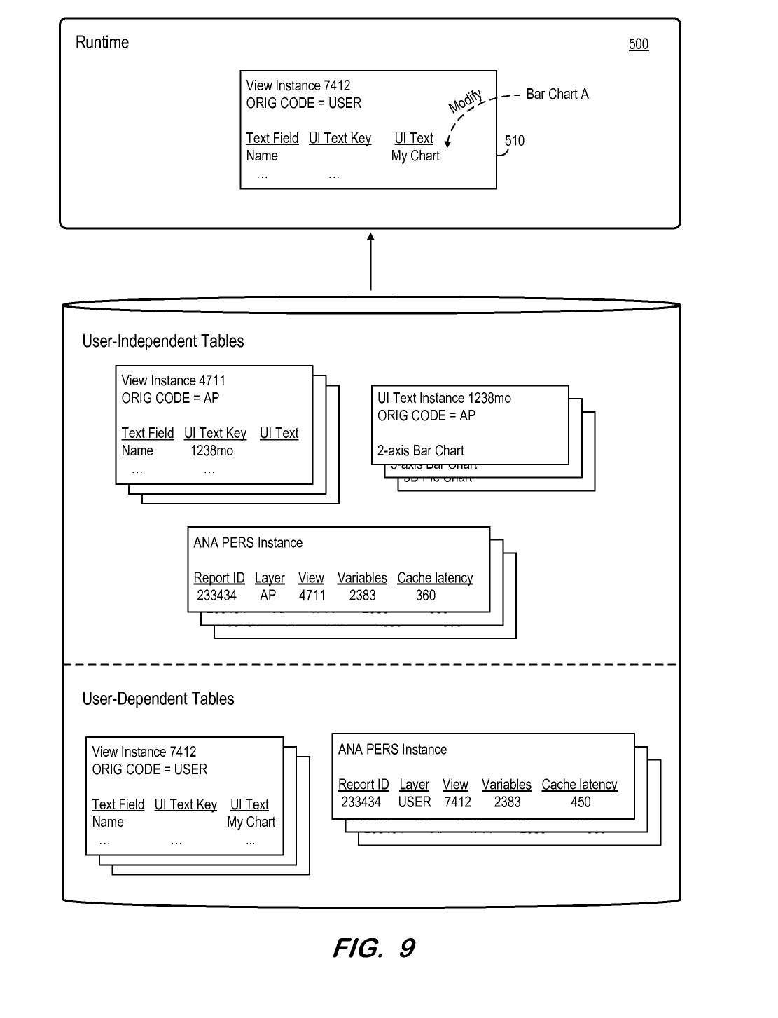

Returning to S602, FIG. 9 illustrates a scenario in which a modification of a text field is received for a view instance having the origin code “USER”. Specifically, Name text field of runtime instance 510, originally presented in FIG. 5, is to be changed from “My Chart” to “Bar Chart A”. Therefore, at S604, and as also illustrated in FIG. 9, a UI text attribute corresponding to the text field in the runtime view instance is modified.

Next, at S606, an instruction is received to save the runtime view instance. It will again be assumed that the instruction is a “Save” operation to overwrite the corresponding persisted view instance, therefore flow proceeds from S608 to S610.

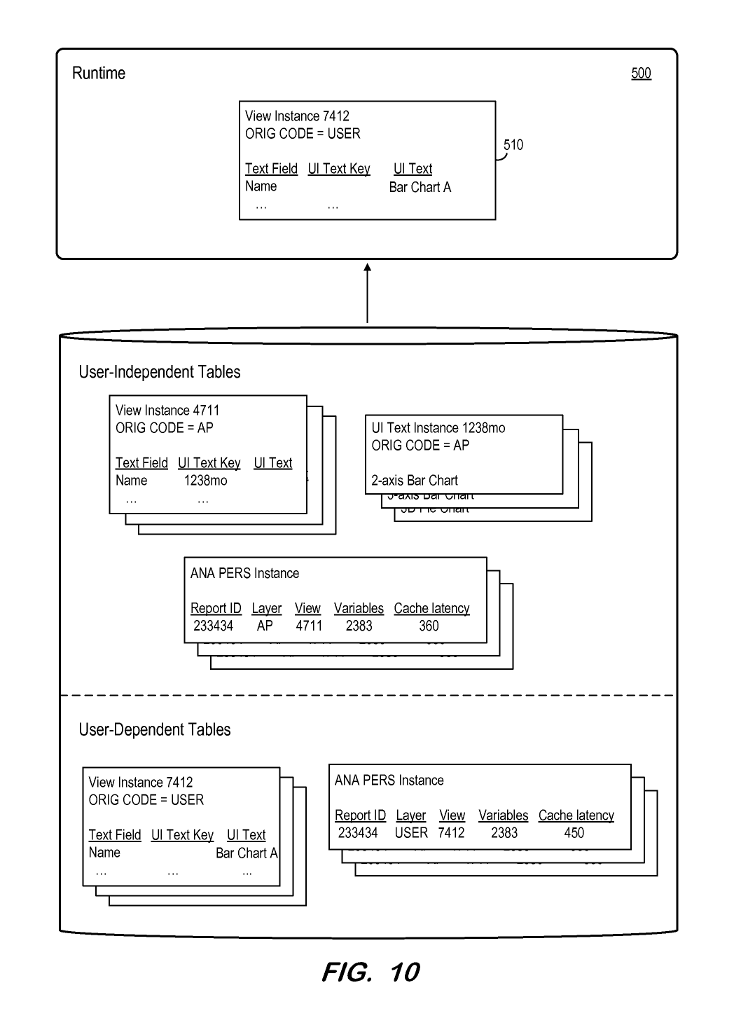

As described above, it is confirmed at S610 that a Save operation is allowed based on the origin code of the runtime view instance and the system environment. Since the origin code is USER, flow continues from S612 to S618. At S618, the UI text attribute of the text field in the corresponding persisted view instance is modified, and this modified view instance is persisted at S620. FIG. 10 shows both the modification of the UI text attribute of runtime instance 510, and the modification of the corresponding UI text attribute of persisted view instance 7412.

It will now be assumed that the modification of FIG. 4 was received at S602 but that a “Save As” command was received at S606. Accordingly, flow proceeds from S608 to S622. Because the origin code of runtime view instance 410 is “AP”, runtime view instance 410 is copied to a new persisted view instance at S624. Then, at S626, a new UI text instance is created and populated with the UI text attribute of the modified text field of the runtime view instance. The new view instance and the new UI text instance are saved in the persistency at S628.

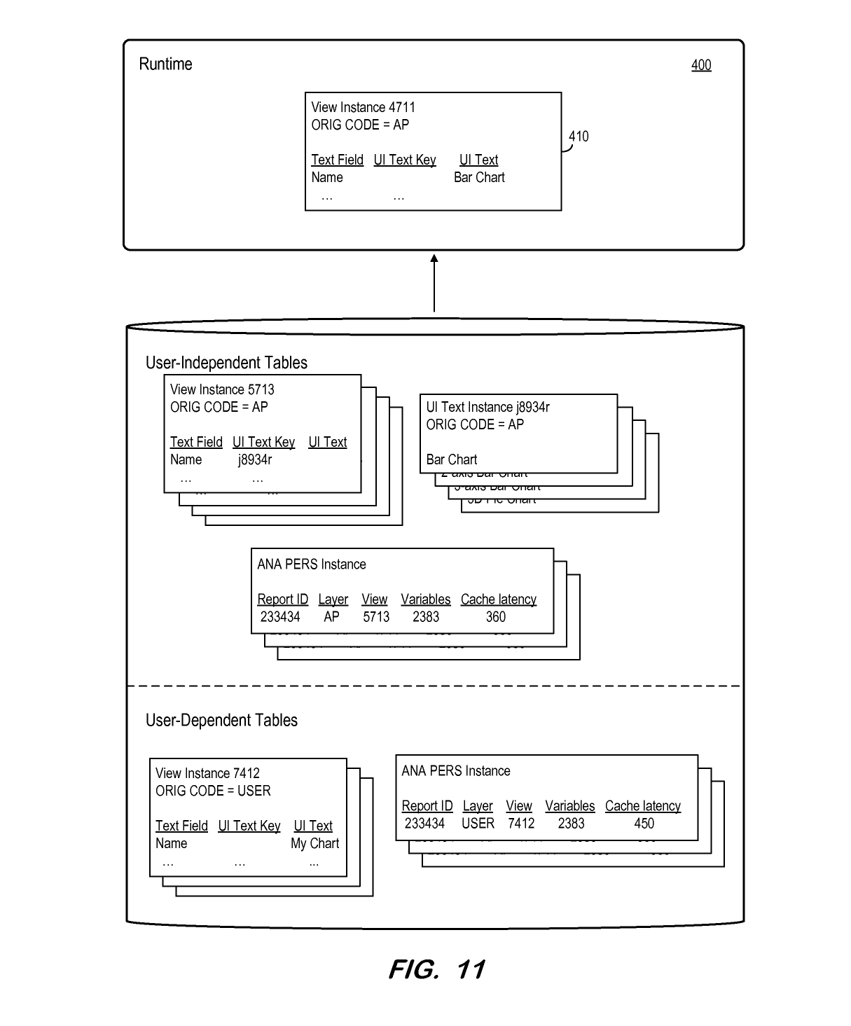

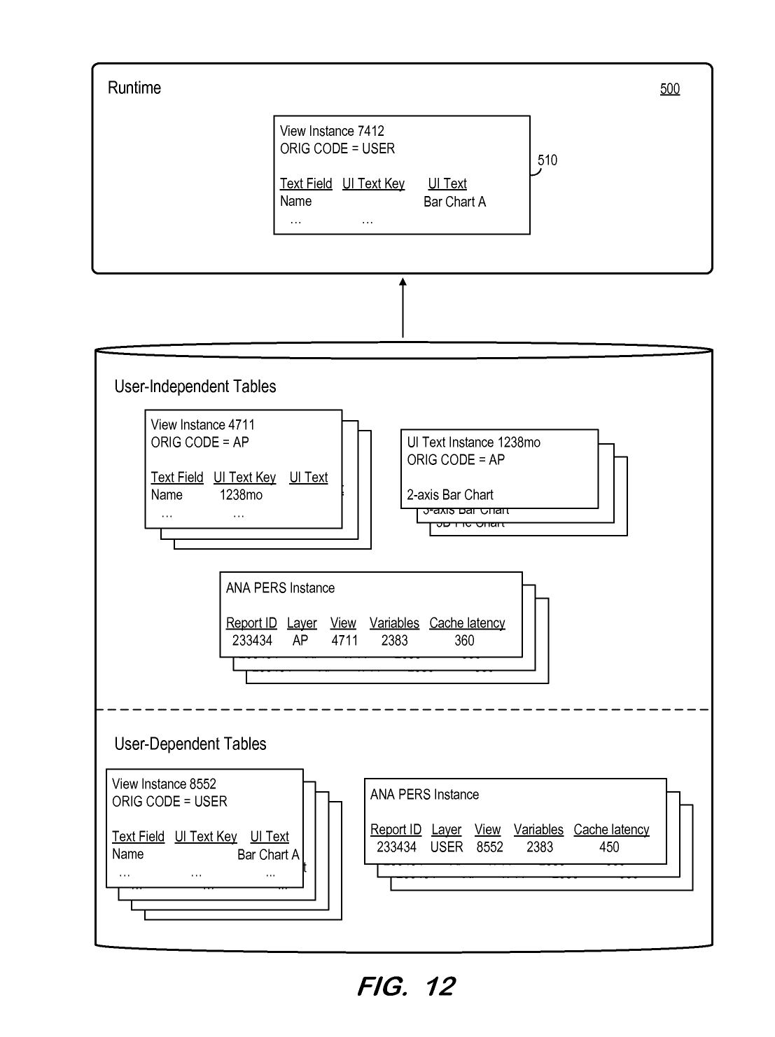

FIG. 11 illustrates new view instance S713 and new UI text instance j8934r created at S624 and S626 according to the present example. New view instance S713 is a copy of runtime instance 410 except for its association of the Name text field with new UI text instance j8934.

Finally, it will be assumed that the modification of FIG. 5 was received at S602 and that a “Save As” command was received at S606. Flow proceeds from S608 to S622 and, because the origin code of runtime view instance 510 is “USER”, runtime view instance 510 is copied to a new persisted view instance at S630. Like runtime view instance 510, new persisted view instance 8552 associates the modified UI text attribute (i.e., Bar Chart A) with the modified text field. The new view instance is saved in the persistency at S632.

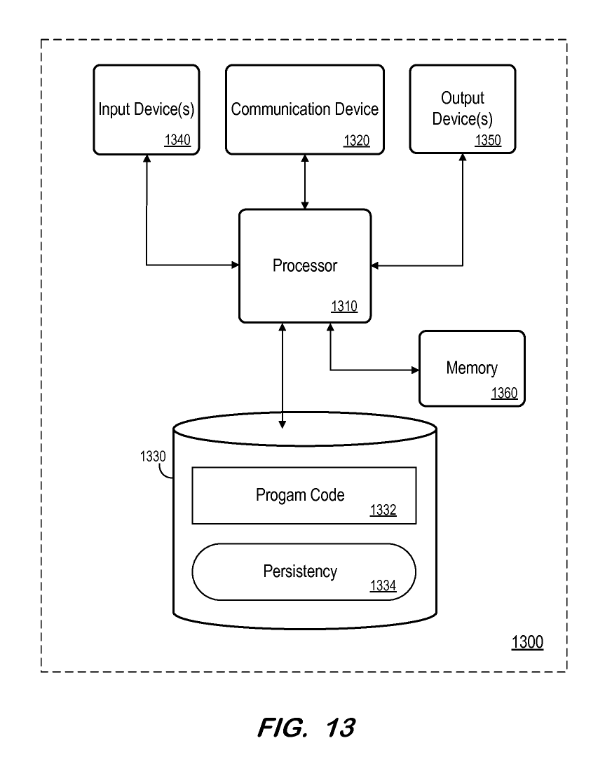

FIG. 13 is a block diagram of apparatus 1300 according to some embodiments. Apparatus 1300 may comprise a general-purpose computing apparatus and may execute program code to perform any of the functions described herein. Apparatus 1300 may comprise an implementation of one or more elements of system 100. Apparatus 1300 may include other unshown elements according to some embodiments.

Apparatus 1300 includes processor 1310 operatively coupled to communication device 1320, data storage device 1330, one or more input devices 1340, one or more output devices 1350 and memory 1360. Communication device 1320 may facilitate communication with external devices, such as an external design tool. Input device(s) 1340 may comprise, for example, a keyboard, a keypad, a mouse or other pointing device, a microphone, knob or a switch, an infra-red (IR) port, a docking station, and/or a touch screen. Input device(s) 1340 may be used, for example, to enter information into apparatus 1300. Output device(s) 1350 may comprise, for example, a display (e.g., a display screen) a speaker, and/or a printer.

Data storage device 1330 may comprise any appropriate persistent storage device, including combinations of magnetic storage devices (e.g., magnetic tape, hard disk drives and flash memory), optical storage devices, Read Only Memory (ROM) devices, etc., while memory 1360 may comprise Random Access Memory (RAM).

Program code 1332 of data storage device 1330 may be executable by processor 1310 to provide any of the processes described herein. Embodiments are not limited to execution of these processes by a single apparatus. Persistency 1334 may include metadata of metaobject instances (i.e., objects), metadata of object instances, and business data as described herein. Data storage device 1330 may also store data and other program code for providing additional functionality and/or which are necessary for operation thereof, such as device drivers, operating system files, etc.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, comprising:
receiving an instruction to launch a report within a usage context;
determining a persisted view instance associated with the report based on the usage context;
generating a runtime view instance based on the persisted view instance;
determining whether the persisted view instance is associated with a first origin code or a second origin code;
if the persisted view instance is associated with the first origin code, populating a text attribute of each text field of the runtime view instance with text of a persisted user interface text instance corresponding to the text field;
if the persisted view instance is associated with the second origin code, populating the text attribute of each text field of the runtime view instance with a respective text attribute of the persisted view instance; and
generating a runtime instance of the report based on the runtime view instance.

2. A method according to claim 1, further comprising:
receiving a modification of a first text field of the runtime view instance;
modifying a text attribute corresponding to the first text field in the runtime view instance;
receiving an instruction to save the runtime view instance;
determining that the runtime view instance is associated with the first origin code;
modifying the persisted user interface text instance based on the modified text attribute of the runtime view instance; and
saving the modified persisted user interface text instance.

3. A method according to claim 1, further comprising:
receiving a modification of a first text field of the runtime view instance;
modifying a text attribute corresponding to the first text field in the runtime view instance;
receiving an instruction to save the runtime view instance;
determining that the runtime view instance is associated with the second origin code;
modifying a respective text attribute of the persisted view instance based on the modified text attribute of the runtime view instance; and
saving the modified persisted view instance.

4. A method according to claim 1, further comprising:
receiving a modification of a first text field of the runtime view instance;
modifying a text attribute corresponding to the first text field in the runtime view instance;
receiving an instruction to save the runtime view instance as a new persisted view instance;
determining that the runtime view instance is associated with the first origin code;
copying the runtime view instance to the new persisted view instance;
creating a new persisted user interface text instance populated with the modified text attribute corresponding to the first text field; and
saving the new persisted view instance and the new persisted user interface text instance.

5. A method according to claim 1, further comprising:
receiving a modification of a first text field of the runtime view instance;
modifying a text attribute corresponding to the first text field in the runtime view instance;
receiving an instruction to save the runtime view instance as a new persisted view instance;
determining that the runtime view instance is associated with the second origin code;
copying the runtime view instance, including the modified text attribute, to the new persisted view instance; and
saving the new persisted view instance.

6. A method according to claim 1, further comprising:
determining a persisted variables instance associated with the report based on the usage context;
generating a runtime variables instance based on the persisted variables instance;
determining whether the persisted variables instance is associated with the first origin code or the second origin code;
if the persisted variables instance is associated with the first origin code, populating a text attribute of each text field of the runtime variables instance with text of a persisted user interface text instance corresponding to the text field; and
if the persisted variables instance is associated with the second origin code, populating the text attribute of each text field of the runtime variables instance with a respective text attribute of the persisted variables instance,
wherein the runtime instance of the report is generated based on the runtime view instance and on the runtime variables instance.

7. A non-transitory medium storing processor-executable program code, the program code executable by a device to:
receive an instruction to launch a report within a usage context;
determine a persisted view instance associated with the report based on the usage context;
generate a runtime view instance based on the persisted view instance;
determine whether the persisted view instance is associated with a first origin code or a second origin code;
populate, if the persisted view instance is associated with the first origin code, a text attribute of each text field of the runtime view instance with text of a persisted user interface text instance corresponding to the text field;
populate, if the persisted view instance is associated with the second origin code, the text attribute of each text field of the runtime view instance with a respective text attribute of the persisted view instance; and
generate a runtime instance of the report based on the runtime view instance.

8. A medium according to claim 7, the program code further executable by a device to:
receive a modification of a first text field of the runtime view instance;
modify a text attribute corresponding to the first text field in the runtime view instance;
receive an instruction to save the runtime view instance;
determine that the runtime view instance is associated with the first origin code;
modify the persisted user interface text instance based on the modified text attribute of the runtime view instance; and
save the modified persisted user interface text instance.

9. A medium according to claim 7, the program code further executable by a device to:
receive a modification of a first text field of the runtime view instance;
modify a text attribute corresponding to the first text field in the runtime view instance;
receive an instruction to save the runtime view instance;
determine that the runtime view instance is associated with the second origin code;
modify a respective text attribute of the persisted view instance based on the modified text attribute of the runtime view instance; and
save the modified persisted view instance.

10. A medium according to claim 7, the program code further executable by a device to:
receive a modification of a first text field of the runtime view instance;
modify a text attribute corresponding to the first text field in the runtime view instance;
receive an instruction to save the runtime view instance as a new persisted view instance;
determine that the runtime view instance is associated with the first origin code;
copy the runtime view instance to the new persisted view instance;
create a new persisted user interface text instance populated with the modified text attribute corresponding to the first text field; and
save the new persisted view instance and the new persisted user interface text instance.

11. A medium according to claim 7, the program code further executable by a device to:
receive a modification of a first text field of the runtime view instance;
modify a text attribute corresponding to the first text field in the runtime view instance;
receive an instruction to save the runtime view instance as a new persisted view instance;
determine that the runtime view instance is associated with the second origin code;
copy the runtime view instance, including the modified text attribute, to the new persisted view instance; and
save the new persisted view instance.

12. A medium according to claim 7, the program code further executable by a device to:
determine a persisted variables instance associated with the report based on the usage context;
generate a runtime variables instance based on the persisted variables instance;
determine whether the persisted variables instance is associated with the first origin code or the second origin code;
populate, if the persisted variables instance is associated with the first origin code, a text attribute of each text field of the runtime variables instance with text of a persisted user interface text instance corresponding to the text field; and
populate, if the persisted variables instance is associated with the second origin code, the text attribute of each text field of the runtime variables instance with a respective text attribute of the persisted variables instance,
wherein the runtime instance of the report is generated based on the runtime view instance and on the runtime variables instance.

13. A system comprising:
a computing device comprising:
a memory system storing processor-executable program code; and
a processor to execute the processor-executable program code in order to cause the computing device to:
receive an instruction to launch a report within a usage context;
determine a persisted view instance associated with the report based on the usage context;
generate a runtime view instance based on the persisted view instance;
determine whether the persisted view instance is associated with a first origin code or a second origin code;
populate, if the persisted view instance is associated with the first origin code, a text attribute of each text field of the runtime view instance with text of a persisted user interface text instance corresponding to the text field;
populate, if the persisted view instance is associated with the second origin code, the text attribute of each text field of the runtime view instance with a respective text attribute of the persisted view instance; and
generate a runtime instance of the report based on the runtime view instance.

14. A system according to claim 13, the processor further to execute the processor-executable program code in order to cause the computing device to:
receive a modification of a first text field of the runtime view instance;
modify a text attribute corresponding to the first text field in the runtime view instance;
receive an instruction to save the runtime view instance;
determine that the runtime view instance is associated with the first origin code;
modify the persisted user interface text instance based on the modified text attribute of the runtime view instance; and
save the modified persisted user interface text instance.

15. A system according to claim 13, the processor further to execute the processor-executable program code in order to cause the computing device to:
receive a modification of a first text field of the runtime view instance;
modify a text attribute corresponding to the first text field in the runtime view instance;
receive an instruction to save the runtime view instance;
determine that the runtime view instance is associated with the second origin code;
modify a respective text attribute of the persisted view instance based on the modified text attribute of the runtime view instance; and
save the modified persisted view instance.

16. A system according to claim 13, the processor further to execute the processor-executable program code in order to cause the computing device to:
receive a modification of a first text field of the runtime view instance;
modify a text attribute corresponding to the first text field in the runtime view instance;
receive an instruction to save the runtime view instance as a new persisted view instance;
determine that the runtime view instance is associated with the first origin code;
copy the runtime view instance to the new persisted view instance;
create a new persisted user interface text instance populated with the modified text attribute corresponding to the first text field; and
save the new persisted view instance and the new persisted user interface text instance.

17. A system according to claim 13, the processor further to execute the processor-executable program code in order to cause the computing device to:
receive a modification of a first text field of the runtime view instance;
modify a text attribute corresponding to the first text field in the runtime view instance;
receive an instruction to save the runtime view instance as a new persisted view instance;
determine that the runtime view instance is associated with the second origin code;
copy the runtime view instance, including the modified text attribute, to the new persisted view instance; and
save the new persisted view instance.

18. A system according to claim 13, the processor further to execute the processor-executable program code in order to cause the computing device to:
determine a persisted variables instance associated with the report based on the usage context;
generate a runtime variables instance based on the persisted variables instance;
determine whether the persisted variables instance is associated with the first origin code or the second origin code;
populate, if the persisted variables instance is associated with the first origin code, a text attribute of each text field of the runtime variables instance with text of a persisted user interface text instance corresponding to the text field; and
populate, if the persisted variables instance is associated with the second origin code, the text attribute of each text field of the runtime variables instance with a respective text attribute of the persisted variables instance,
wherein the runtime instance of the report is generated based on the runtime view instance and on the runtime variables instance.
